(19) United States
(12) Patent Application Publication
(10) Pub. No.: US 2008/0106878 A1
(43) Pub. Date: May 8, 2008

(54) Circuit configuration having a number of electrical components

(76) Inventors: Bruno Stenzel, Bramsche (DE); Andreas Falk, Oldenburg (DE); Thorsten Weiss, Valencia (ES)

Correspondence Address: COLLARD & ROE, P.C., 1077 NORTHERN BOULEVARD, ROSLYN, NY, 11576, US

(21) Appl. No.: 11/593,321

(22) Filed: Nov. 6, 2006

(51) Int. Cl. H01R 9/00

(52) U.S. Cl. 361/774

(57) ABSTRACT

In a circuit configuration having a number of electrical components and having at least one line element which electrically connects the components to one another, the line element is a wire-like stamped part which is inserted into the circuit configuration separately from other line elements.

The components of this circuit configuration are to be equipped simply and cost-effectively with electrically conductive line elements.

The present invention relates to a circuit configuration having a number of electrical components and having at least one line element, which electrically connects the components to one another.

Circuit configurations of the species cited at the beginning are used, for example, in motor vehicles. In addition to the mechanical actuation of motor vehicle parts and/or motor vehicle assemblies, electrical and/or electronically controlled actuation of these components and assemblies is increasingly performed. Thus, mechanical components are no longer used solely in the area of a door lock in the doors of a motor vehicle, but rather also electrical components. These electrical components comprise terminal elements for electrical lines guided therein, and they comprise switches for control motors and the like. Electrical components situated in the area of a door are frequently accommodated in the circuit configuration in a lock shell, which may be preassembled as a complete module and inserted later in the door of the motor vehicle.

The various components of the circuit configuration are accommodated in a lock shell of this type. The components are to be electrically connected to one another. For this purpose, stamped screens have been suggested in the prior art as line elements, which comprise a series of electrical lines, each of which is stamped out. In the production of stamped screens of this type, however, a large quantity of scrap of the stamped material arises, so that a relatively large amount of waste arises. Another possibility for implementing the electrical lines are line films, which have printed conductors manufactured from copper within an insulating film, for example. The scrap is reduced in these line elements, however, the production of these line elements is complex and thus correspondingly costly.

The present invention is based on the object of disclosing a circuit configuration of the species cited at the beginning whose components are to be equipped simply and cost-effectively with electrically conductive line elements.

This object is achieved according to the present invention in that the line element is a wire-like stamped part, which is inserted into the circuit configuration separately from other line elements.

A stamped-out screen is not used in the circuit configuration according to the present invention. Rather, each line element is preferably a wire-like stamped part, which is insertable in the circuit configuration separately from other line elements. This requires each line element to be a wire-like stamped part which is manufactured, i.e., stamped, separately from other line elements. Wire-like stamped parts may thus be stamped continuously from a metal sheet, for example, used for the stamping, without a large quantity of sheet metal scrap arising. The wire-like stamped parts have the original thickness of the stamped sheet, and are capable of conducting electrical current. Each wire-like stamped part may be situated independently from the others in the circuit configuration and adapted to the local conditions of the circuit configuration by bending the wire-like stamped part, for example.

According to a first refinement of the present invention, the stamped part has a uniform thickness over its length. Since the stamped part is manufactured from a stamped sheet, it has a uniform thickness if this metal sheet is a metal sheet having a uniform thickness over its extension. The uniform thickness of the stamped part ensures homogeneous electrical conduction properties.

According to a next refinement, the stamped part at least partially has a square cross-section. The thickness of the stamped part is equal to its width in the sections having a square cross-section. This embodiment advantageously causes the stamped part to be able to be angled in any direction without greater forces counteracting bending of the stamped part. The bending properties of a flexible cord having a circular cross-section are nearly achieved by the implementation of the cross-section as a square. The stamped part may be angled via any of its four surfaces, twisting and/or torsion also being possible without the stamped part tearing.

For further implementation of the present invention, the cross-section of the stamped part is preferably rectangular at least in the area of one of its free ends. The free ends of the stamped part are regularly assigned to the electrical components, since the stamped part is to be situated as an electrical line element between these components. However, a secure connection of the line elements to the components is to be ensured in the area of these electrical components. The stamped part, which is broadened in this area, is used for this secure connection, since the width of the stamped part increases at uniform thickness due to the embodiment of the cross-section of the stamped part in rectangular form. Terminals of switches or plug configurations, for example, may be attached, preferably soldered, to these broadened sections of the stamped part. Furthermore, angling of these broadened areas of the stamped part is possible, however, angling is then normally performed via only one of the two broadened sides of the stamped part, however, to tailor these broadened sections optimally to a receptacle for plugs or switches, for example. After the electrical components are connected to the sections of the stamped part, the electrical components may be embedded or sealed and fixed in another way.

According to a next refinement of the present invention, the stamped part is at least partially electrically insulated. Through the insulation, it is possible to bring the sections of two stamped parts proximal to one another and/or lay them one on top of the other without an electrical short-circuit occurring. The broadened free ends of the stamped part are preferably not provided with electrical insulation, to allow the connection of the electrical components here. However, electrical insulation may also be used there, which is canceled out with the aid of soldering heat, for example, when the electrical components are attached.

The insulation of the stamped part is preferably implemented as lacquering. For example, an elastic insulating lacquer is used for this lacquering, which is also used in transformer construction.

The thickness of each stamped part may be approximately 0.4 mm to 1.2 mm, for example. Stamped parts having this thickness are adaptable to the local conditions even in compact circuit configurations by bending the printed conductors in such a way that they come to rest in a space-saving way in the circuit configuration.

Several fixing points may be provided over the length of the stamped part for situating the stamped parts in a lock shell of a motor vehicle, for example. These are used in particular if multiple stamped parts are provided which cross one another.

An exemplary embodiment of the present invention, from which further features according to the present invention result, is shown in the drawing.

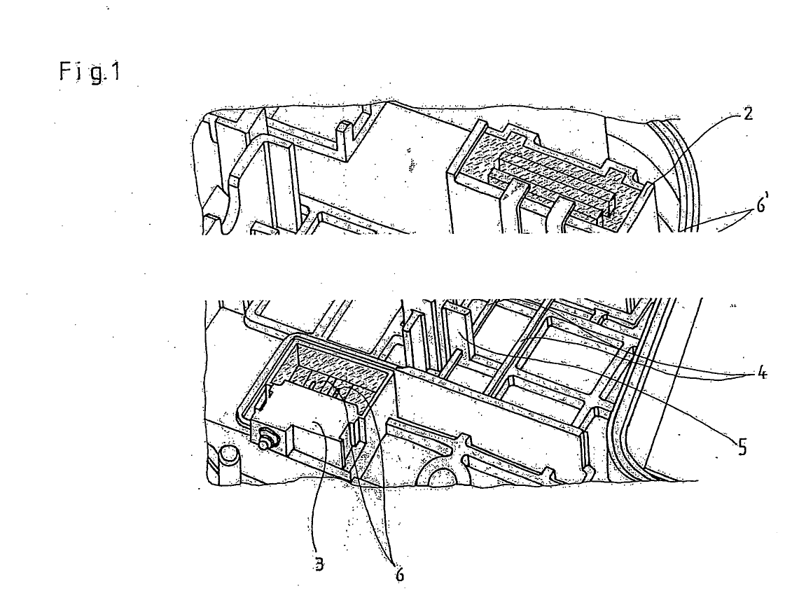

FIG. 1: shows a perspective view of a circuit configuration according to the present invention,

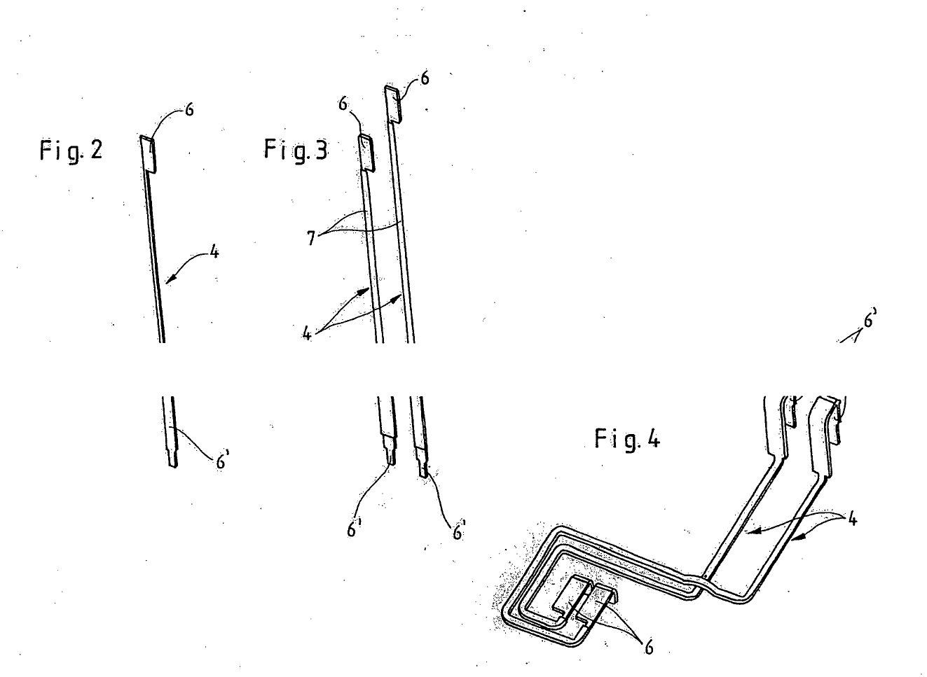

FIGS. 2 and 3: show line elements used for the circuit configuration in FIG. 1, and

FIG. 4: show line elements for use in a circuit configuration from FIG. 1 immediately before insertion into a circuit configuration of this type.

The circuit configuration in FIG. 1 is situated in a housing which is a lock shell 1 for a lock in a motor vehicle. The lock shell 1 is manufactured from plastic. A plug terminal 2 and a switch 3 are inserted into the lock shell 1.

The electrical components 2, 3 are to be electrically connected to one another. Stamped parts 4, which are implemented as wire-like and which are each inserted independently from one another into the lock shell 1, are used for this electrical line. The stamped parts 4 are provided with bends so that they are adapted to the local conditions in the lock shell 1. In addition, a stamped part 4 of this type may be fixed using a projection 5 protruding from the floor of the lock shell 1.

FIG. 2 shows that a stamped part 4 has sections implemented differently from one another. A section is provided in a middle area in which the stamped part 4 has a square cross-section. A broadened terminal area 6, 6′ is provided in the area of each of the free ends of the stamped part 4. The thickness of the stamped part 4 is equal over its entire extension. However, the width of the stamped part 4 is increased in the terminal areas 6, 6′.

FIG. 3 shows that the stamped parts 4 may have different lengths from one another. The sections having a square cross-section are coated with an insulating lacquer 7 in FIG. 3. The terminal areas 6, 6′ remain partially free to allow electrical conductors of the plug terminal 2 and the switch 3 to be soldered on.

FIG. 4 shows how two stamped parts 4 are bent before being inserted into the lock shell 1. The sections having a square cross-section may be bent in various directions without tearing of the stamped parts 4 occurring. The terminal areas 6 and/or 6′, in contrast, are bent in a defined way over their broader surfaces, so that they receive a hook-like implementation. It may be seen from FIG. 1 that the hook-like implementation of the terminal area 6′, for example, is used for the purpose of overcoming the wall of a trough-like receptacle of the plug terminal 2. The plug terminal 2 is embedded using a casting compound after the electrical connection of terminal areas 6′ and plug components.

The terminal areas 6 are provided for the switch 3. They are introduced into the surface of the floor of the lock shell 1, so that the terminal areas 6 are situated flush in a surface. The electrical contacts of the switch 3 are electrically connected to the terminal areas 6, the terminals are also embedded here subsequently to avoid corrosion influences.

1. A circuit configuration having a number of electrical components and having at least one line element which electrically connects the components to one another, wherein the line element is a wire-like stamped part (4), which is inserted into the circuit configuration separately from other line elements.

2. The circuit configuration according to claim 1, wherein the stamped part (4) has a uniform thickness over its length.

3. The circuit configuration according to claim 1, wherein the stamped part (4) at least partially has a square cross-section.

4. The circuit configuration according to claim 1, wherein the cross-section of the stamped part (4) is rectangular at least in the area (6,6′) of one of its free ends.

5. The circuit configuration according to claim 1, wherein the stamped part (4) is at least partially electrically insulated.

6. The circuit configuration according to claim 5, wherein the insulation is implemented by a lacquering.

7. The circuit configuration according to claim 6, wherein an elastic insulating lacquer (7) is used for the lacquering.

8. The circuit configuration according to claim 1, wherein the thickness of the stamped part (4) is approximately 0.4 mm to 1.2 mm.
